(19) United States
(12) Patent Application Publication
(10) Pub. No.: US 2015/0326644 A1
(43) Pub. Date: Nov. 12, 2015

(54) TRAVELING MAP-REDUCE ARCHITECTURE

(71) Applicant: Microsoft Corporation, Redmond, WA (US)

(72) Inventors: Saar Yahalom, Tel Aviv (IL); Nadav Bar, Tel Aviv (IL)

(73) Assignee: Microsoft Corporation, Redmond, WA (US)

(21) Appl. No.: 14/271,548

(22) Filed: May 7, 2014

(51) Int. Cl. H04L 29/08; G06F 21/62; G06F 17/30

(52) U.S. Cl. CPC H04L 67/10; G06F 17/30592; G06F 21/6218

(57) ABSTRACT

A “traveling” map-reduce operation with full context that can skip between data stores and devices. The “traveling” aspect means the map-reduce operation request can be communicated to specific agents to operate on local data of the agents. The traveling map-reduce operation protects privacy and avoids leakage of user private data. The traveling map-reduce operation can run over long periods of time and work on data stores which are not always connected (offline). The architecture employs a context free online controller and a set of on-premise (on device) agents that reside in the data store (device).

### BACKGROUND

Running a map-reduce algorithm requires all the data to be readily available, usually in an online data cluster (datastore), and a main controller which orchestrates the data collection and the map-reduce definitions. This means that the data being analyzed has to reside in a shared location, which can expose the data to possible privacy infringement. There is no way to run a map-reduce operation on distributed, and possibly private, data that is not continuously available, or is not available due to privacy regulations. In addition, there is no context free controller that enables the run of long duration map-reduce operations across devices (or datastores).

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a “traveling” map-reduce operation with full context that can skip between data stores and devices. The “traveling” aspect is intended to mean that the map-reduce operation request, context, and results can be communicated (shipped) to and through specific agents to operate on local data of the agents. The traveling map-reduce operation protects privacy and avoids exposure of user private data. The traveling map-reduce operation can run over long periods of time and work on datastores which are not always connected (offline). The architecture employs a “context free” online controller and a set of on-premise (on device) agents that reside in the data store (device). The controller is context free in that the context automatically changes as the map-reduce operation moves from agent to agent.

In a general operational description, the map-reduce operation (request) is submitted to the controller from some consumer or other service or program. The map-reduce operation contains the map and the reduce operation definitions along with the set of agent properties that indicate agents to participate in the map-reduce operation. The controller communicates with one or more of the agents to submit the map-reduce operation. An agent runs the map-reduce operation on the local data while preserving the data privacy. Context information as to the currently running agent of the map-reduce operation is updated to reflect the results of running the map-reduce operation on the local data, and the agent entry in the context is updated to reflect that the agent has completed the operation. When the agent is completed, the agent sends the updated map-reduce operation context and results to the controller or to another agent. The controller then retargets, or the agent runs and forwards, the traveling map-reduce operation to a new agent, and the process repeats to completion of the map-reduce session.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a serial implementation flow of a map-reduce system in accordance with the disclosed architecture.

FIG. 3 illustrates a peer implementation flow of a map-reduce system in accordance with the disclosed architecture.

FIG. 4 illustrates a parallel implementation flow of a map-reduce system in accordance with the disclosed architecture.

FIG. 5 illustrates a location-based peer-to-peer implementation flow of a map-reduce system in accordance with the disclosed architecture.

FIG. 6 illustrates a combination implementation flow of a map-reduce system in accordance with the disclosed architecture.

FIG. 7 illustrates a dataset that can be communicated by the controller and agents to accomplish the map-reduce operation session.

FIG. 8 illustrates a method in accordance with the disclosed architecture.

FIG. 9 illustrates an alternative method in accordance with the disclosed architecture.

FIG. 10 illustrates a block diagram of a computing system that executes the traveling map-reduce architect.

### DETAILED DESCRIPTION

Map-reduce processing is generally understood to be a framework for processing problems in parallel across huge datasets using a large number of computers (nodes), collectively referred to clusters. Map-reduce can take advantage of the locality of data by processing data on or near the storage assets to decrease data transmission costs.

The disclosed architecture is a “traveling” map-reduce operation with full context that can skip between datastores and devices, based on the device selected for the operation. The “traveling” aspect is intended to mean that the map-reduce operation request can be communicated to and through specific agents to operate on local data of the agents. The traveling map-reduce operation protects privacy and avoids the exposure of user private data. The traveling map-reduce operation can run over long periods of time and work on data stores which are not always connected (offline). The architecture employs a context free online controller and a set of on-premise (on device) agents that reside in the data store (device).

In a general operational description, the map-reduce operation (request) is submitted to the controller to obtain results for some consumer or other service or program. The map-reduce operation contains the map and the reduce operation definitions along with the set of agent properties that indicate agents to participate in the map-reduce operation. The controller communicates with the agents to submit the map-reduce operation. The agent runs the map-reduce operation on the local data while preserving the data privacy. Context information as to the currently operation agent of the map-reduce operation is updated to reflect the results of running the map-reduce operation on the local data, and the agent entry in the context is updated to reflect that the agent has completed the operation. When the agent is completed, the agent sends the updated map-reduce operation context and results to the controller. The controller then retargets the traveling map-reduce operation to a new agent, and the process repeats. However, as described herein, the agent can bypass the controller and forward the map-reduce operation directly to another agent.

The following examples illustrate real-world benefits of the disclosed architecture. In a first example, it is desired to find the trendiest location in a city (using the traveling map-reduce operation while protecting user location information). Consider that a context free controller is running as an online cloud service, for example, and a set of mobile phones exist running a map-reduce agent (e.g., a device side service that acts as the map-reduce agent). The map-reduce operation is defined to run over the on-device stored data locations and produce a list of counters per city tile according to the on-device locations. The tile counter list is saved in the map-reduce operation context. Accordingly, the tile counter list travels from one mobile device to another (using the controller as a mediator, if necessary). The user location data never leaves the device itself—only crude location information is shared cross the devices.

In a second example, it is desired to find the trendiest musical group using a traveling map-reduce operation, while protecting user data. Consider that a context free controller is running as an online cloud service, for example, and a set of mobile phones exist running a map-reduce agent (e.g., a device side service that acts as the map-reduce agent). A map-reduce operation is defined to run over the on-device stored data of music records and produce a list of counters per music group according to the on-device records. The counter list is saved in the map-reduce operation context, and hence, since the context information is sent to the next mobile phone agent, the counter list travels from one mobile device to another (using the controller as a mediator, if necessary). The user data never leaves the device itself—only crude musical group information is shared cross the devices without the data being related back to a specific user or user device.

In a third example, it is desired to find the average number of calls that are made by teenage females in San Francisco (the “Bay Area”). Consider that a context free controller is running as an online cloud service, for example, and a set of mobile phones exist running a map-reduce agent (e.g., a device side service that acts as the map-reduce agent). A map-reduce operation is defined to trigger agents with specific properties. In this case the properties are location (“Bay Area”), gender (“female”) and age (“group 12-17”).

The map-reduce operation is set to run over the on-device call log records and produce the average number of calls during a 24-hour period. The average number of calls is saved in the map-reduce operation context and passed to the next agent. Thus, the map-reduce context and results “travel” from one mobile device to another (using the controller as a mediator, if necessary). The user phone call data never leaves the device itself—only crude statistics information is shared cross the devices without being related back to a specific user or user device.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

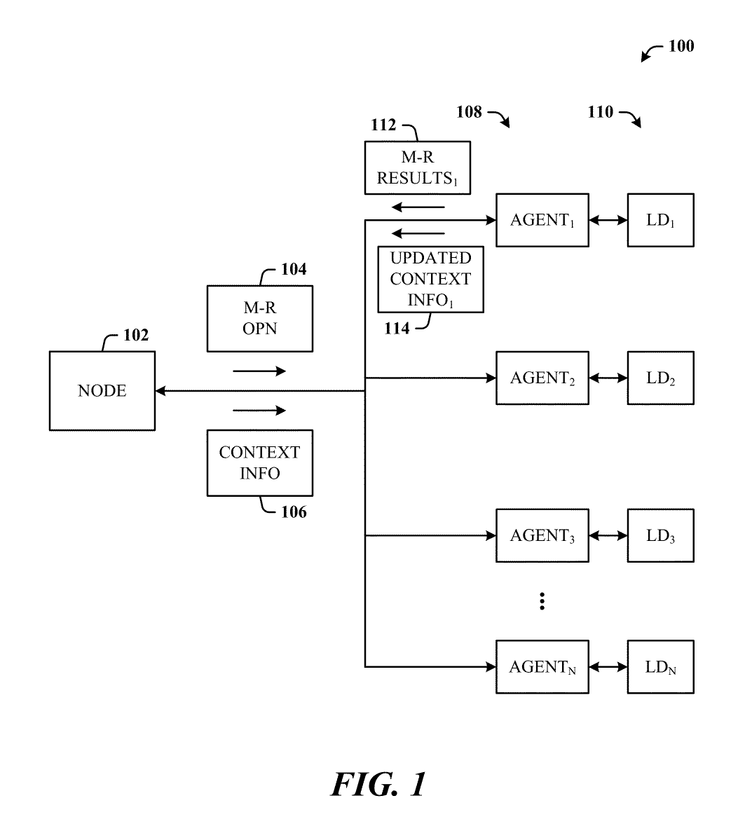

FIG. 1 illustrates a system 100 in accordance with the disclosed architecture. The system 100 can include a node 102 configured to conduct a map-reduce session by sending a map-reduce operation (M-R OPN) 104 and context information 106 to agents (AGENTS_{1-N}) 108. The agents 108 each execute the map-reduce operation 104 on associated local data (LD) of local data (LD_{1-N}) 110 to obtain map-reduce results (e.g., M-R RESULTS' 112) and update of the corresponding context information (e.g., UPDATED CONTEXT INFO′ 114). The node 102 receives the map-reduce results from the agents 108 and updated context information from the agents 108 based on (as part of) the map-reduce session.

The local data can comprise data generated and stored in association with different programs such as a scheduling program, a voice program, an image processing program, a text generation and editing program, etc. Thus, the local data can comprise text, images, audio, video, and any combinations thereof. The local data can be stored in one or more locations on the local device such as a single hard drive or multiple hard drives, external drives, and so on.

It is also within contemplation of the disclosed architecture that for data that may be stored at a location different than the user device, the map-reduce operation can “follow” a path (e.g., a hyperlink) to the remote data to process the remote data as well, or alternatively to the on-premise data. For example, in devices that lack sufficient local storage and yet generate data, the data may be uploaded to a remote datastore as part of normal data operations. Thus, where remote datastores host the map-reduce agent, the remote data stores can execute the agent to work on the data “local” to the remote datastore and return result and updated context information to the device, and from the device to the node 102.

The node 102 can execute (complete) the map-reduce session in a parallel manner by sending the map-reduce operation 104 in parallel to designated (e.g., all, one or some) agents (e.g., Agent₁, Agent₃, etc.) of the agents 108 and receives the corresponding map-reduce results (e.g., M-R RESULTS₁ 112) and updated context information (e.g., UPDATED CONTEXT INFO₁ 114) of the agents (e.g., designated) that have completed the map-reduce operation.

The node 102 may also execute (complete) the map-reduce session serially by sending the map-reduce operation to an agent (e.g., Agent₁) and receiving map-reduce results and context update information of the agent (e.g., Agent₁) before accessing another agent (e.g., Agent₂) in the map-reduce session.

The node 102 can be a controller node that handles (manages) the map-reduce session for all designated agents 108. Alternatively, or in combination therewith, an agent (e.g., Agent₁) can act as the controller and handles the map-reduce session for other designated agents (e.g., Agent₂, Agent₃, etc.). The node 102 can run as an online cloud service. Each of the agents 108 is a map-reduce program that operates as a device-side service.

The map-reduce results (e.g., M-R RESULTS₁ 112) of an agent (e.g., AGENT₁) comprise data that is unidentifiable as derived and obtained from a given agent and relates to a given user and user device. Thus, the privacy of data included as part of the results from any given user device is maintained as part of the map-reduce agent operation. The node 102 outputs the map-reduce results and updated context information from one, some or all of the designated agents 108 to a consumer (not shown) when a minimum threshold of results is received from the agents 108. The consumer can be another network service, for example.

In one implementation, one agent passes on-going operation context information and map-reduce results to other reachable agents before new on-going operation context and new map-reduce results obtained from the reachable agents are passed to the node 102.

Following is a description of various implementations map-reduce. For example, the implementations include, but are not limited to: in series, in parallel, both in series and in parallel, agent peer-to-peer, location-based execution, and so on.

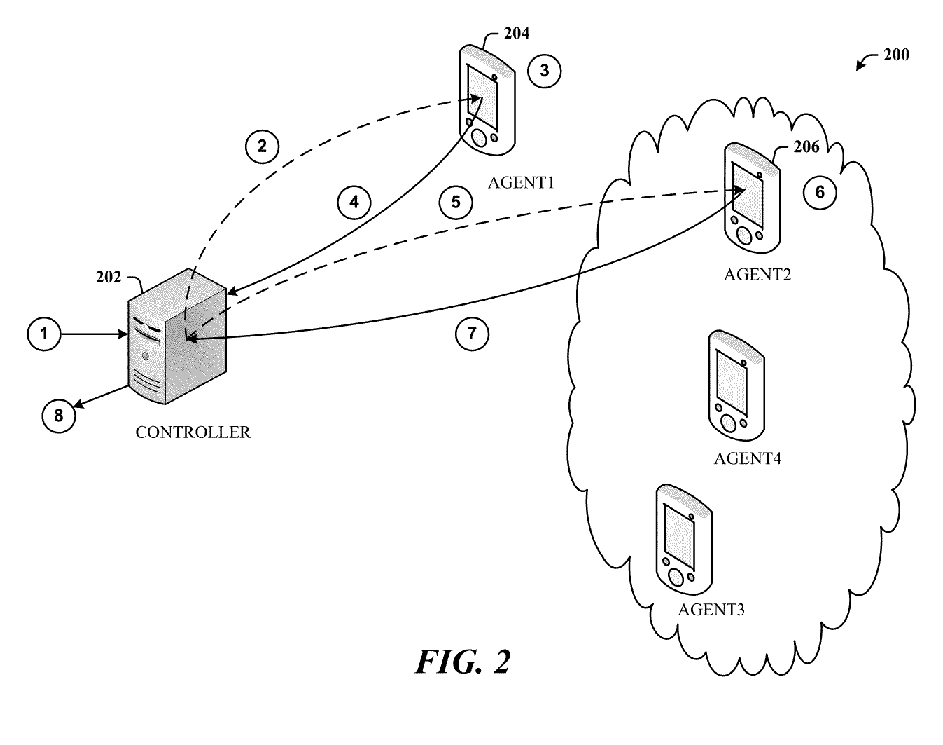

FIG. 2 illustrates a serial implementation flow of a map-reduce system 200 in accordance with the disclosed architecture. The system 200 can comprise a “context free” online controller 202 and a set of on-premise (on device) agents, where the agents reside in or in association with, the datastore (device).

Initially, at \textcircled{1}, a “traveling” (distributed execution) map-reduce operation is submitted to the controller 202 (similar to the node 102). The map-reduce operation contains map and reduce operation definitions along with the set of agent properties of agents designated to participate in this map-reduce session.

At \textcircled{2}, the controller 202 communicates with a first “on-premise” agent 204 (an agent is “on-premise” when it resides on a device or with the local data) to submit the map-reduce operation (that includes the definitions) to the designated agent.

It can be the case that although the first agent 204 was the first designated agent on the list, the first agent 204 is offline to the controller 202. In such cases, the controller 202 can proceed to contact the next agent on the designated agent list. This process can continue until an online agent is found. Additionally, once the online agents are completed processed, the controller 202 and/or last online agent can route the map-reduce operation to the next-in-line missed or offline agent that is now back online and to exhaust “retries” until some predetermined limit is reached (e.g., attempt at most five retries before considering the agent unreachable).

It can be the case that the controller 202 also sends an initialized set of context information to the first agent 204 as well; although this is not a requirement as the first agent 204 can automatically generate the context information if such information has not been received with the map-reduce operation (request).

At \textcircled{3}, the first agent 204 executes the map-reduce operation on its local data to obtain map-reduce results, and then updates the operation context information. The map-reduce context is updated to reflect the results of running the map-reduce operation on the local data of the first agent 204, and a “running” agent entry in the context information is updated to reflect that the first agent 204 has completed the map-reduce operation.

The map-reduce operation preserves data privacy as coming from an unidentifiable source (e.g., the user identity or user device identity), and processes the local data in a way that prevents the exposure of source identity information that might have been in the data and associated with the data.

At \textcircled{4}, as included in the context information for this implementation, the first agent 204 uses the controller 202 as a mediator (or proxy) to pass the on-going operation and context to a next agent such as a second agent 206. The controller 202 retargets the distributed map-reduce operation to a new agent (e.g., a second agent 206) based on the update context information.

At \textcircled{5}, the controller 202 communicates with the second “on-premise” agent 206, in accordance with the updated context information from the first agent 204, to submit the map-reduce operation (that includes the definitions) the next (e.g., online) agent on the list—the second agent 206.

At \textcircled{6}, the second agent 206 executes the map-reduce operation on its local data to obtain map-reduce results, and then updates the operation context information. The map-reduce context information is updated to reflect the results of running the map-reduce operation on the local data of the second agent 206, and an agent entry in the context information is updated to reflect that the second agent 206 has completed the map-reduce operation.

At \textcircled{7}, as included in the context information for this implementation, if the second agent 206 is the last agent in this particular map-reduce session, the second agent 206 sends the map-reduce operation, associated context information, and the map-reduce results back to the controller 202.

At \textcircled{8}, the controller 202 outputs the map-reduce results to the requesting entity. It can be the case that the controller 202 only outputs the results when a minimum threshold of results is attained as received from the agents (204 and 206). For example, the minimum threshold can be determined as a percentage (e.g., eighty percent) of the reachable (online) agents that responded. It can also be the case that the threshold varies according to the specific kind of results (e.g., weather conditions) being collected and the timing (e.g., now or within the next hour) in which the results are desired. It can also be based on the type of data requested, such as only image data, or only video data.

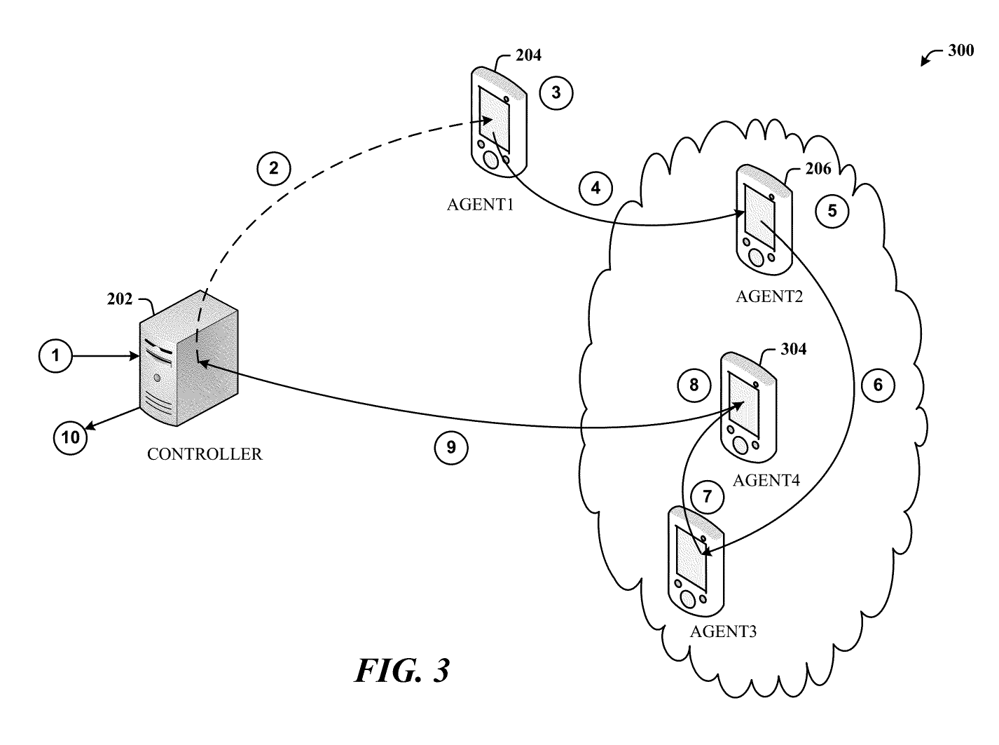

FIG. 3 illustrates a peer implementation flow of a map-reduce system 300 in accordance with the disclosed architecture. Thus, the controller 202 is bypassed as an intermediary function during peer communications of the map-reduce operation, until the final agent has completed. The system 300 comprises the online controller 202 and a set of on-premise agents: the first agent 204, the second agent 206, a third agent 302 and a fourth agent 304, where the agents reside in or in association with, the local data (e.g., device drive storage).

Initially, at \textcircled{1}, a “traveling” (distributed execution) map-reduce operation is submitted to the controller 202 (similar to the node 102). The map-reduce operation contains map and reduce operation definitions along with the set of agent properties of agents (designated to participate in this map-reduce session.

At \textcircled{2}, the controller 202 communicates with a first “on-premise” agent 204 to submit the map-reduce operation (that includes the definitions) to the designated agent (e.g., the first agent 204).

It can be the case that although the first agent 204 was the first designated agent on the list, the first agent 204 is offline to the controller 202. In such cases, the controller 202 can proceed to contact the next agent on the designated agent list, such as the second agent 206. This process can continue until an online agent is found. Additionally, once the online agents are completed processed, the controller 202 and/or last online agent (e.g., the fourth agent 304) can route the map-reduce operation to the next-in-line missed or offline agent that is now back online and to exhaust “retries” until some predetermined limit is reached (e.g., attempt at most five retries before considering the agent unreachable).

It can be the case that the controller 202 also sends an initialized set of context information to the first agent 204 as well; although this is not a requirement, as the first agent 204 can automatically generate the context information if such information has not been received with the map-reduce operation (request).

At \textcircled{3}, the first agent 204 executes the map-reduce operation on its local data to obtain map-reduce results, and then updates the operation context information. The map-reduce context is updated to reflect the results of running the map-reduce operation on the local data of the first agent 204, and a “running” agent entry in the context information is updated to reflect that the first agent 204 has completed the map-reduce operation.

The map-reduce operation preserves data privacy as coming from an unidentifiable source (e.g., the user identity or user device identity), and processes the local data in a way that prevents the exposure of source identity information that might have been in the data and associated with the data.

At \textcircled{4}, as included in the context information for this implementation, the first agent 204 passes the on-going operation (request) and context directly to the second agent 206 (bypassing the controller 202).

At \textcircled{5}, the second agent 206 executes the map-reduce operation on its local data to obtain map-reduce results, and then updates the operation context information. The map-reduce context information is updated to reflect the results of running the map-reduce operation on the local data of the second agent 206, and an agent entry in the context information is updated to reflect that the second agent 206 has completed the map-reduce operation.

At \textcircled{6}, as included in the context information for this implementation, the second agent 206 passes the on-going operation (request) and context directly to the third agent 302 (bypassing the controller 202).

At \textcircled{7}, the third agent 302 executes the map-reduce operation on its local data to obtain map-reduce results, and then updates the operation context information. The map-reduce context information is updated to reflect the results of running the map-reduce operation on the local data of the third agent 302, and an agent entry in the context information is updated to reflect that the third agent 302 has completed the map-reduce operation. As included in the context information for this implementation, the third agent 302 passes the on-going operation (request) and context directly to the fourth agent 304 (bypassing the controller 202).

At \textcircled{8}, the fourth agent 304 executes the map-reduce operation on its local data to obtain map-reduce results, and then updates the operation context information. The map-reduce context information is updated to reflect the results of running the map-reduce operation on the local data of the fourth agent 304, and an agent entry in the context information is updated to reflect that the fourth agent 304 has completed the map-reduce operation.

As included in the context information for this implementation, the fourth agent 304 is the last online and responding agent in this map-reduce session. Thus, at \textcircled{9}, the fourth agent 304 sends the map-reduce operation, associated context information, and the map-reduce results back to the controller 202.

At \textcircled{10}, the controller 202 outputs the map-reduce results to the requesting entity. It can be the case that the controller 202 only outputs the results when a minimum threshold of results is attained as received from the agents (204, 206, 302 and 304). For example, the minimum threshold can be determined as a quorum (e.g., simply majority) or a percentage (e.g., eighty percent) of the reachable (online) agents that responded. It can also be the case that the threshold varies according to the specific kind of results (e.g., weather conditions) being collected and the timing (e.g., now or within the next hour) in which the results are desired. It can also be based on the type of data requested, such as only image data, or only video data.

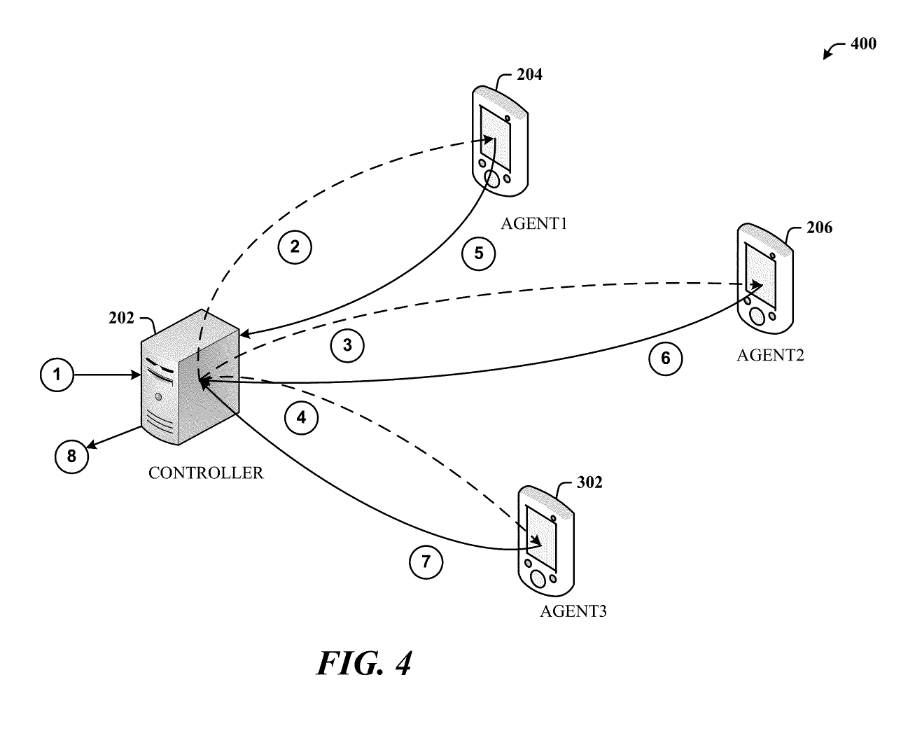

FIG. 4 illustrates a parallel implementation flow of a map-reduce system 400 in accordance with the disclosed architecture. The system 400 can comprise the controller 202 and a set of on-premise (on device) agents, where the agents reside in or in association with, the datastore (device).

Initially, at \textcircled{1}, a distributed execution map-reduce operation is submitted to the controller 202 (similar to the node 102). The map-reduce operation contains map and reduce operation definitions along with the set of agent properties of agents designated to participate in this map-reduce session.

At \textcircled{2}, \textcircled{3}, and \textcircled{4}, the controller 202 communicates in parallel with each of the agents (204, 206 and 302) to submit the map-reduce operation (that includes the definitions) to the designated agents.

Each of the agents (204, 206, and 302) operates independently to execute the map-reduce operation on its local data to obtain map-reduce results and to then update the corresponding operation context information. The map-reduce context is updated to reflect the results of running the map-reduce operation on the local data of the agents (204, 206 and 302), and a “running” agent entry in the context information is updated to reflect that the corresponding agents (204, 206, and 302) have completed the map-reduce operation.

The map-reduce operation preserves data privacy as coming from an unidentifiable source (e.g., the user identity or user device identity), and processes the local data in a way that prevents the exposure of source identity information that might have been in the data and associated with the data.

At \textcircled{5}, \textcircled{6}, and \textcircled{7} each of the corresponding agents (204, 206, and 302) sends the map-reduce operation, associated context information, and the map-reduce results back to the controller 202. The controller 202 than processes the results and context information of the agents (204, 206, and 302) into a final set of results and context information to ensure sufficient agents have responded with the desired information.

At \textcircled{8}, the controller 202 outputs the map-reduce results to the requesting entity. It can be the case that as before, the controller 202 only outputs the results when a minimum threshold of results is attained as received from the agents (204 and 206). For example, the minimum threshold can be determined as a percentage (e.g., eighty percent) of the reachable (online) agents that responded. It can also be the case that the threshold varies according to the specific kind of results (e.g., weather conditions) being collected and the timing (e.g., now or within the next hour) in which the results are desired. It can also be based on the type of data requested, such as only image data, or only video data.

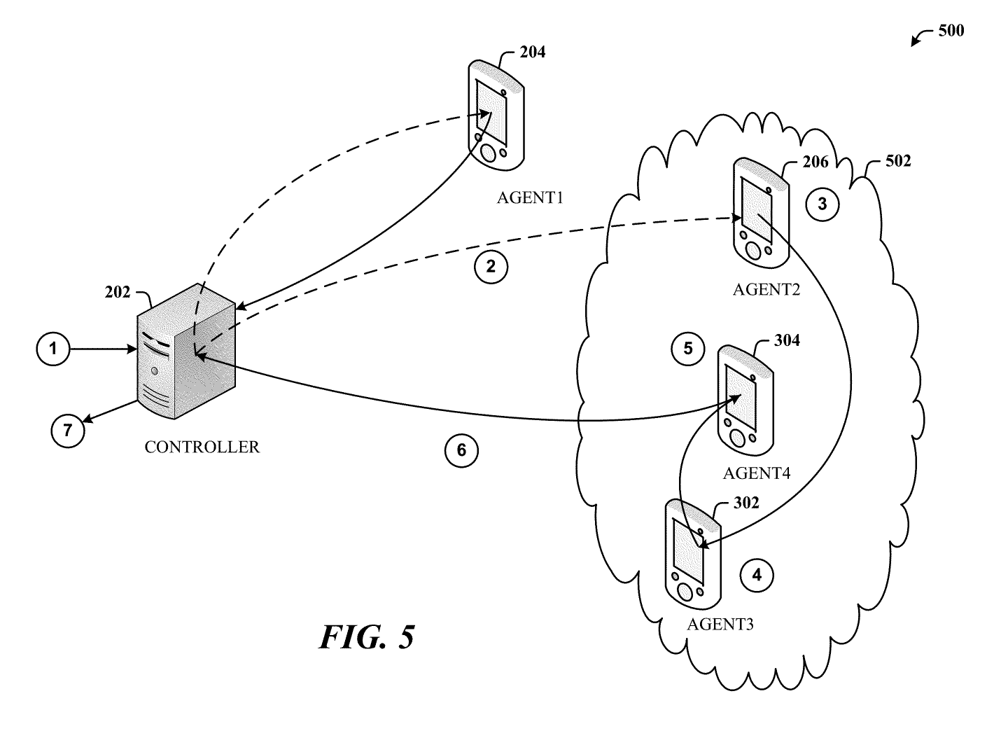

FIG. 5 illustrates a location-based peer-to-peer implementation flow of a map-reduce system 500 in accordance with the disclosed architecture. In this implementation, map-reduce operation session is directed to agents determined to be associated with a specific geographical area 502 or to have had some level of relevancy to the area 502.

Initially, at \textcircled{1}, a distributed execution map-reduce operation is submitted to the controller 202. The map-reduce operation contains map and reduce operation definitions along with the set of agent properties of agents designated to participate in this map-reduce session. While the first agent 204 may have been designated to the session, a source of information may indicate that for substantially realtime benefits, the first agent 204 is no longer relevant for the desired information since first agent 204 is no longer associated with the area 502 and perhaps has not been for some predetermined time (“aged out”). Accordingly, the controller 202 may override and dismiss the first agent 204 from the session processing.

This pre-session participation determination by the controller 202 (or some other suitable component that interfaces to the controller 202) can be accomplished with a brief communication to the designated agents (204, 206, 302, and 304) such as for geolocation information, for example. In any case, the second agent 206, the third agent 302, and the fourth agent 304 are determined to be closely associated with the area 502 and will be processed during the map-reduce session.

Thus, at \textcircled{2}, the controller 202 communicates to an agent, for example, the first agent 204, to initiate the session by submitting the map-reduce operation (request). At \textcircled{3}, the second agent 206 executes the map-reduce operation on its local data to obtain map-reduce results, and then updates the operation context information. The map-reduce context is updated to reflect the results of running the map-reduce operation on the local data of the second agent 206, and a “running” agent entry in the context information is updated to reflect that the second agent 206 has completed the map-reduce operation. As included in the context information for this implementation, the second agent 206 passes the on-going operation (request) and context directly to the third agent 302 (bypassing the controller 202).

At \textcircled{4}, the third agent 302 executes the map-reduce operation on its local data to obtain map-reduce results, and then updates the operation context information. The map-reduce context information is updated to reflect the results of running the map-reduce operation on the local data of the third agent 302, and an agent entry in the context information is updated to reflect that the third agent 302 has completed the map-reduce operation. As indicated in the context information for this implementation, the third agent 302 passes the on-going operation (request) and context directly to the fourth agent 304 (bypassing the controller 202).

At \textcircled{5}, the fourth agent 304 executes the map-reduce operation on its local data to obtain map-reduce results, and then updates the operation context information. The map-reduce context information is updated to reflect the results of running the map-reduce operation on the local data of the fourth agent 304, and an agent entry in the context information is updated to reflect that the fourth agent 304 has completed the map-reduce operation. As included in the context information for this implementation, the fourth agent 304 passes the results and updated context directly to the controller 202. At \textcircled{7}, the controller 202 outputs the map-reduce results to the requesting entity.

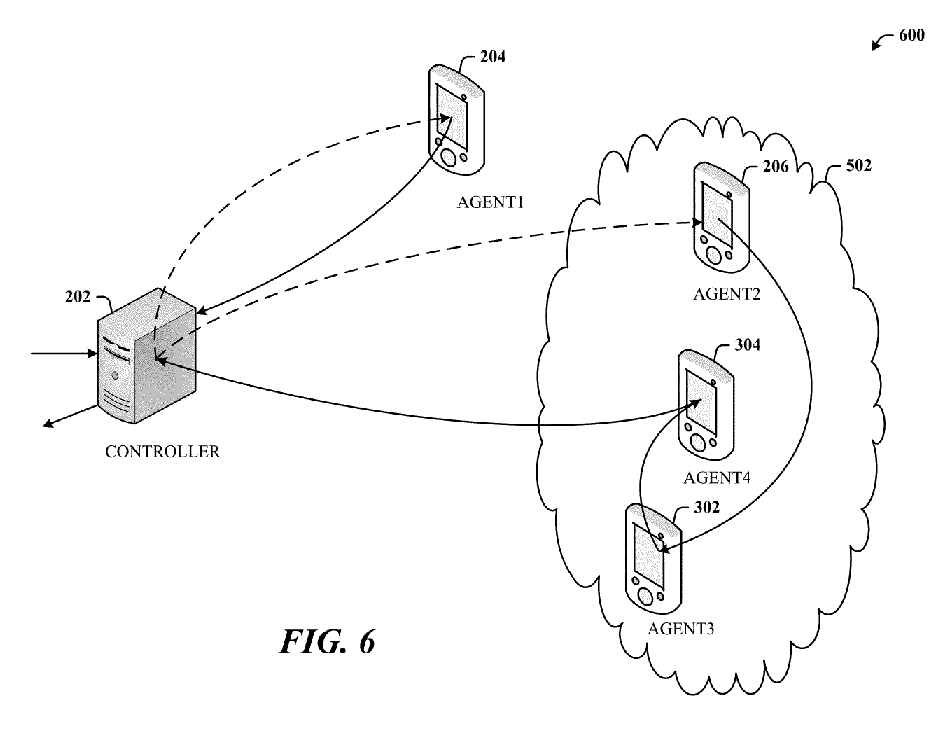

FIG. 6 illustrates a combination implementation flow of a map-reduce system 600 in accordance with the disclosed architecture. Here, the combination implementation enables serial, parallel, and peer-to-peer map-reduction processing. In this example, the controller 202 initiates the map-reduce operation serially to the first agent 204, which can be in parallel to concurrently sending the map-reduce operation to the second agent 206.

The second agent 206 then operates to continue the map-reduction session with the third agent 302 and fourth agent 304 in a peer fashion. Ultimately, the fourth agent returns the results and updated context to the controller 202, as does the first agent 204.

In all of the above implementations, it is desirable that each of the agents is capable of providing the final results for viewing in some understandable (viewer-friendly) way on some or all of the agent devices and/or different agent devices not part of the current session.

Additionally, it is to be understood that in the disclosed architecture, certain components may be rearranged, combined, omitted, and additional components may be included.

Although not shown, a privacy component can be employed for an additional layer of secure handling of user and device information. The privacy component can enable the user to opt-in and opt-out of local data access.

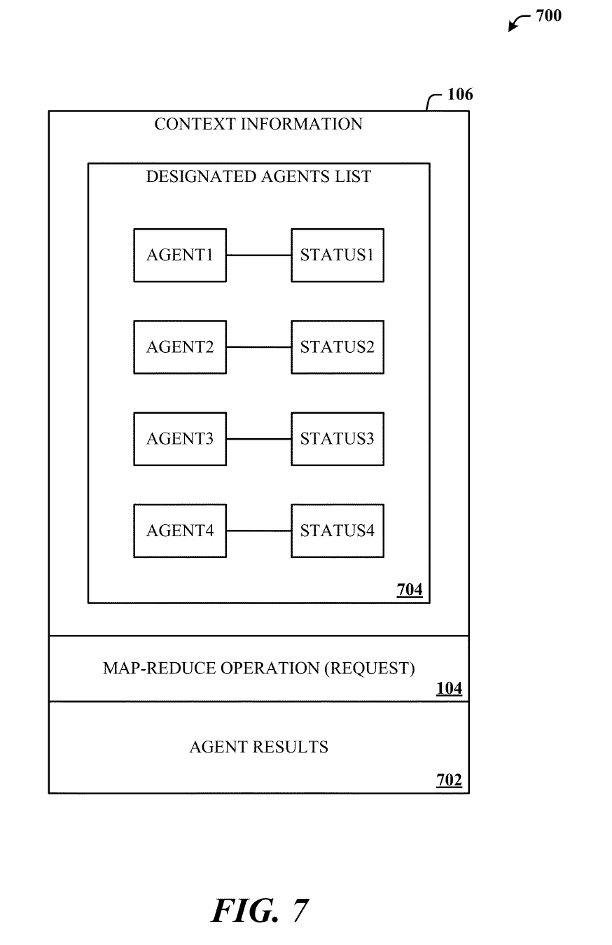

FIG. 7 illustrates a dataset 700 that can be communicated by the controller and agents to accomplish the map-reduce operation session. The dataset 700 can comprise the context information 106, the map-reduce operation (request) 104, and agent results 702. The context information 106 can further comprise a designated agents list 704, which indicates the particular agents to be requested for map-reduce operation. The list 704 facilitates defining the agent properties such as an agent identifier (e.g., AGENT1) and status (STATUS1) of the map-reduce operation for the given agent, such as values that represent “incomplete” or “complete”, for example.

The list 704 can also indicate the order in which the agents can be processed, such as according to a ranked or top-down priority. When the first agent completes the operation, the first agent references the list 704 to see that the second agent is next for map-reduction processing. However, if the second agent is unreachable (“offline” to the first agent, the first agent moves to the next agent, the third agent. This similar operation can be performed by the controller 202 to direct context information 106, map-reduce operation (request) 104, and results 702 to subsequently indicated agents on the list 704.

The agent results 702 can be an aggregation of the prior results of the correspondingly prior agents that will be processed ultimately by the controller 202, or an interim result compilation of the results obtained after each agent is completed, for example.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

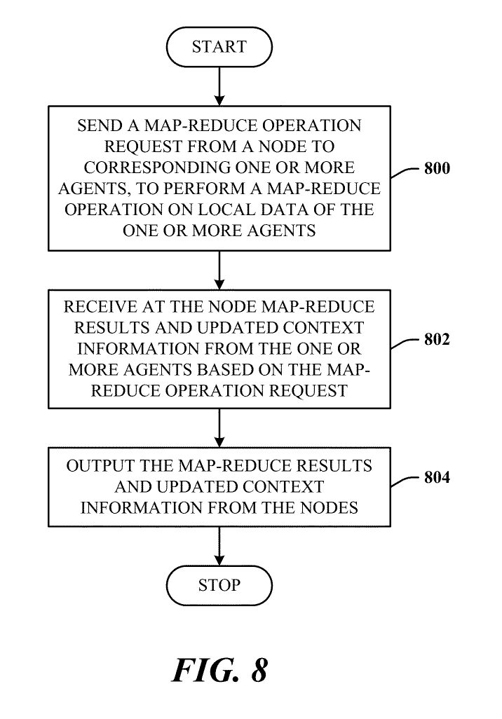

FIG. 8 illustrates a method in accordance with the disclosed architecture. At 800, a map-reduce operation request is sent from a node to corresponding one or more agents, to perform a map-reduce operation on local data of the one or more agents. At 802, map-reduce results and updated context information are received at the node from the one or more agents based on the map-reduce operation request. At 804, the map-reduce results and updated context information are output from the node.

The method can further comprise preserving privacy of the local data as part of the map-reduce operation on the agents. The method can further comprise updating the context to identify that a given agent has completed the map-reduce operation. The method can further comprise redirecting the map-reduce operation request to an online agent that was previously offline.

The method can further comprise sending the map-reduce operation request in parallel to designated agents. The method can further comprise sending the map-reduce operation request serially through designated agents of a list of designated agents. The method can further comprise incrementally accumulating the map-reduce results and updated context information from one agent with another agent, at the node.

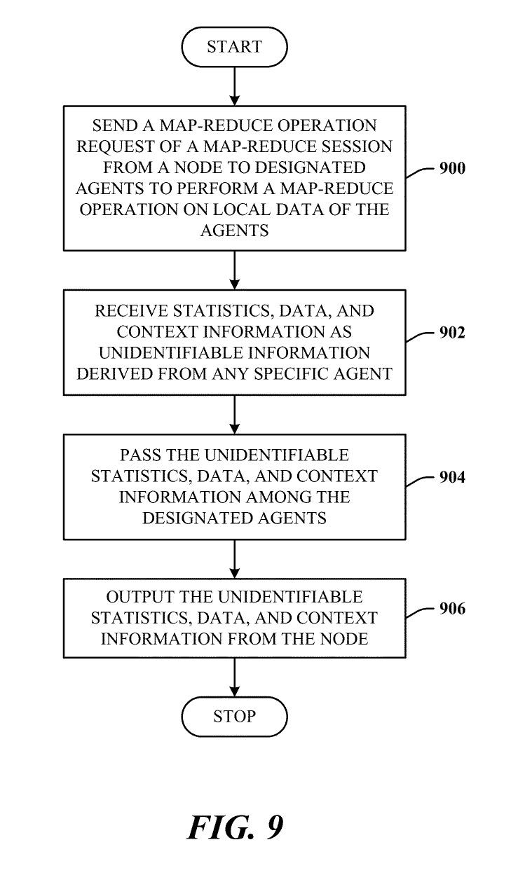

FIG. 9 illustrates an alternative method in accordance with the disclosed architecture. The method can be embodied in a computer-readable storage medium comprising computer-executable instructions that when executed by a microprocessor, cause the microprocessor to perform the following acts.

At 900, a map-reduce operation request of a map-reduce session is sent from a node to designated agents to perform a map-reduce operation on local data of the agents. At 902, statistics, data, and context information are received as unidentifiable information derived from any specific agent. At 904, the unidentifiable statistics, data, and context information is passed among the designated agents. At 906, the unidentifiable statistics, data, and context information are output from the node.

The computer-readable storage medium can further comprise sending the map-reduce operation request in parallel to the designated agents. The computer-readable storage medium can further comprise sending the map-reduce operation request to a designated first agent, receiving the unidentifiable statistics, data, and context information from the first designated agent, serially passing the unidentifiable statistics, data, and context information of the first designated agent to a second designated agent. The computer-readable storage medium, wherein the node receives map operation definitions and reduce operation definitions and a set of agent properties of agents participating in the map-reduce session.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

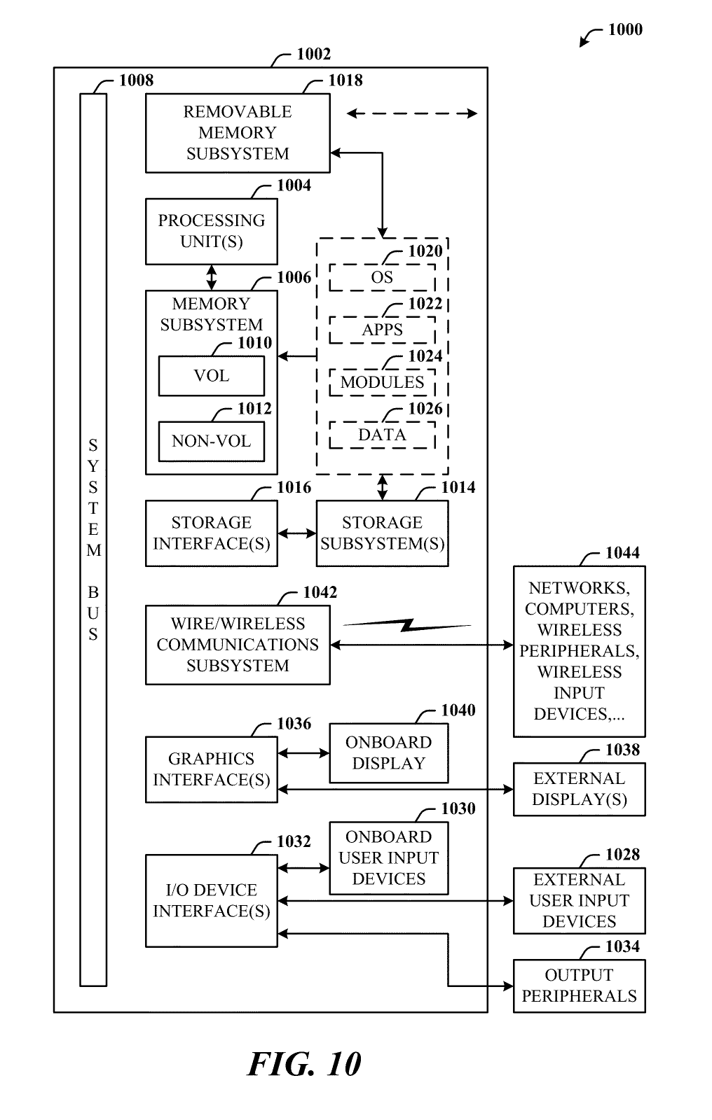

Referring now to FIG. 10, there is illustrated a block diagram of a computing system 1000 that executes the traveling map-reduce architect. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having microprocessing unit(s) 1004 (also referred to as microprocessor(s) and processor(s)), a computer-readable storage medium such as a system memory 1006 (computer readable storage medium/media also include magnetic disks, optical disks, solid state drives, external memory systems, and flash memory drives), and a system bus 1008. The microprocessing unit(s) 1004 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1002 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1006 can include computer-readable storage (physical storage) medium such as a volatile (VOL) memory 1010 (e.g., random access memory (RAM)) and a non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the microprocessing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components and circuits. The storage subsystem(s) 1014 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include items and components of the system 100 of FIG. 1, items and components of the implementation flows of systems 200, 300, 400, 500, and 600, items of the dataset 700 of FIG. 5, and the methods represented by the flowcharts of FIGS. 8 and 9, for example.

Generally, programs include routines, methods, data structures, other software components, etc., that perform particular tasks, functions, or implement particular abstract data types. All or portions of the operating system 1020, applications 1022, modules 1024, and/or data 1026 can also be cached in memory such as the volatile memory 1010 and/or non-volatile memory, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1002, and include volatile and non-volatile internal and/or external media that is removable and/or non-removable. For the computer 1002, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1002, programs, and data using external user input devices 1028 such as a keyboard and a mouse, as well as by voice commands facilitated by speech recognition. Other external user input devices 1028 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1002, programs, and data using onboard user input devices 1030 such a touchpad, microphone, keyboard, etc., where the computer 1002 is a portable computer, for example.

These and other input devices are connected to the microprocessing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a node configured to conduct a map-reduce session by sending a map-reduce operation and context information to agents, the agents each execute the map-reduce operation on associated local data to obtain map-reduce results and update of the corresponding context information, the node receives the map-reduce results from the agents and updated context information from the agents based on the map-reduce session; and
at least one microprocessor configured to execute computer-executable instructions in a memory associated with the node.

2. The system of claim 1, wherein the node completes the map-reduce session in parallel by sending the map-reduce operation in parallel to designated agents and receives the corresponding map-reduce results and updated context information of the agents that have completed the map-reduce operation.

3. The system of claim 1, wherein the node completes the map-reduce session serially by sending the map-reduce operation to an agent and receiving map-reduce results and context update information of the agent before accessing another agent in the map-reduce session.

4. The system of claim 1, wherein the node is a controller node that handles the map-reduce session for all designated agents or an agent that acts as the controller and handles the map-reduce session for other designated agents.

5. The system of claim 1, wherein the node runs as an online cloud service.

6. The system of claim 1, wherein each agent is map-reduce program that operates as a device-side service.

7. The system of claim 1, wherein the map-reduce results of an agent comprise data that is unidentifiable as obtained from a given agent and user device.

8. The system of claim 1, wherein the node outputs the map-reduce results and updated context information to a consumer when a minimum threshold of results is received from the agents.

9. The system of claim 1, wherein one agent passes on-going operation context and map-reduce results to other reachable agents before new on-going operation context and new map-reduce results obtained from the reachable agents are passed to the node.

10. A method, comprising acts of:
sending a map-reduce operation request from a node to corresponding one or more agents, to perform a map-reduce operation on local data of the one or more agents;
receiving at the node map-reduce results and updated context information from the one or more agents based on the map-reduce operation request; and
outputting the map-reduce results and updated context information from the node.

11. The method of claim 10, further comprising preserving privacy of the local data as part of the map-reduce operation on the agents.

12. The method of claim 10, further comprising updating the context to identify that a given agent has completed the map-reduce operation.

13. The method of claim 10, further comprising redirecting the map-reduce operation request to an online agent that was previously offline.

14. The method of claim 10, further comprising sending the map-reduce operation request in parallel to designated agents.

15. The method of claim 10, further comprising sending the map-reduce operation request serially through designated agents of a list of designated agents.

16. The method of claim 10, further comprising incrementally accumulating the map-reduce results and updated context information from one agent with another agent, at the node.

17. A computer-readable storage medium comprising computer-executable instructions that when executed by a microprocessor, cause the microprocessor to perform acts of:
sending a map-reduce operation request of a map-reduce session from a node to designated agents to perform a map-reduce operation on local data of the agents;
receiving statistics, data, and context information as unidentifiable information derived from any specific agent;
passing the unidentifiable statistics, data, and context information among the designated agents; and
outputting the unidentifiable statistics, data, and context information from the node.

18. The computer-readable storage medium of claim 17, further comprising sending the map-reduce operation request in parallel to the designated agents.

19. The computer-readable storage medium of claim 17, further comprising sending the map-reduce operation request to a designated first agent, receiving the unidentifiable statistics, data, and context information from the first designated agent, serially passing the unidentifiable statistics, data, and context information of the first designated agent to a second designated agent.

20. The computer-readable storage medium of claim 17, wherein the node receives map operation definitions and reduce operation definitions and a set of agent properties of agents participating in the map-reduce session.
